(19) United States
(12) Patent Application Publication
(10) Pub. No.: US 2016/0352737 A1
(43) Pub. Date: Dec. 1, 2016

(54) HEART RATE DATA BASED ACCESS

(71) Applicant: Jacob B. Pitman, San Antonio, TX (US)

(72) Inventor: Jacob B. Pitman, San Antonio, TX (US)

(21) Appl. No.: 15/169,927

(22) Filed: Jun. 1, 2016

Related U.S. Application Data
(60) Provisional application No. 62/169,292, filed on Jun. 1, 2015.

(51) Int. Cl. H04L 29/06; G06Q 20/10; G06F 19/00

(52) U.S. Cl. CPC H04L 63/10; G06F 19/322; G06Q 20/10

(57) ABSTRACT

Heart rate data based access can include restricting access to functionality of an electronic apparatus via a restrictive component, receiving heart rate data for a user via the restrictive component, providing access to the functionality of the electronic apparatus for a duration of time via the restrictive component in response to the received heart rate data meeting a threshold for beats per minute over a period of time, and restricting access to the functionality of the electronic apparatus after the duration of time.

### PRIORITY INFORMATION

This application claims benefit of U.S. Provisional Application No. 62/169,292, filed Jun. 1, 2015, the contents of which are incorporated herein by reference.

### BACKGROUND

use of computers, smartphones, tablets, websites, gaming systems, and technology, as a whole, is abundant. While these technologies provide benefits, they may also come with an increased adoption of a sedentary lifestyle by users. A sedentary lifestyle may result in lower caloric expenditure. According the Centers for Disease Control and Prevention, being overweight and obese is the result of a caloric imbalance. That is, too few calories are expended for the amount of calories consumed. This can also be affected by various genetic, behavioral, and/or environmental factors.

According to the Centers for Disease Control and Prevention, 30.5 percent of the United States population (ages 2 years and older) are overweight or obese. Some previous approaches to managing weight may include managing caloric intake (e.g., food consumption) and caloric expenditure (e.g., exercise). Although such approaches may be useful when utilized properly, lack of motivation may hinder adoption of such approaches to managing weight as behavioral and/or environmental changes. Behavioral and/or environmental changes may help ensure that techniques for managing caloric intake and caloric expenditure turn into daily habits that may be more likely to change a person's life for the better. The issues of lack of behavioral and/or environmental changes have not been address properly to this date. Although caloric intake management may be improved by the ability to scan food labels using an application on a smartphone, which can directly input the caloric value of the item consumed based on the users input of the quantity of the item consumed, the lack of behavioral and/or environmental changes may be one of the biggest road blocks to tracking a person's food intake which will assist manage their caloric intake.

### BRIEF DESCRIPTION OF THE DRAWINGS

FIG. 1 illustrates a method flow diagram for heart rate data based access.

FIG. 2 illustrates a flow chart for heart rate data based access.

FIG. 3 illustrates a diagram of a non-transitory machine readable medium for heart rate data based access.

FIG. 4 illustrates a diagram of a non-transitory machine readable medium for heart rate data based access.

FIG. 5 illustrates a diagram of a system for heart rate data based access.

FIG. 6 illustrates a diagram of a machine for heart rate data based access.

FIGS. 7A-7E illustrate diagrams of examples of systems for heart rate data based access to an electronic apparatus.

FIG. 8 illustrates a system for heart rate data based access.

### DETAILED DESCRIPTION

The present disclosure relates to heart rate data based access. At least one embodiment of the present disclosure includes restricting access to functionality of an electronic apparatus via a restrictive component, receiving heart rate data for a user via the restrictive component, providing access to the functionality of the electronic apparatus for a duration of time via the restrictive component in response to the received heart rate data meeting a threshold for beats per minute over a period of time, and restricting access to the functionality of the electronic apparatus after the duration of time. As used herein, a “user” is a user of the electronic apparatus and of the heart rate monitor. Some embodiments of the present disclosure can help to create behavioral and/or environmental changes within users, which promotes the adoption of caloric intake and expenditure management methods. The behavioral and/or environmental changes, according to the present disclosure, can benefit the users. In some instances, the benefits may last for the rest of their lives.

Heart rate data (e.g., from a heart rate monitor and/or a database associated with a heart rate monitor) can be used to restrict and/or provide access to a functionality of an electronic apparatus. Examples of electronic apparatuses include televisions, computers (e.g., desktops and/or laptops), tablets, smartphones, and gaming systems (e.g., PlayStation®, Xbox®, etc.), among others. Examples of functionality of electronic apparatuses include overall operation of the electronic apparatus, executable instructions (e.g., a program), a game, a web browser, a web browser for a particular website (e.g., access to certain websites can be restricted while access to other websites is provided), an application (e.g., an app on a smartphone), a dialer, a dialer for a particular telephone number (e.g., access to certain telephone numbers can be restricted while access to other telephone numbers is provided), a text message application, and a text message application for a particular recipient (e.g., access to text messaging with a particular recipient can be restricted while access to text messaging with other recipients is provided), among others.

Some embodiments of the present disclosure can require that a heart rate of a user (as indicated by heart rate data) be within a threshold for beats per minute (BPM) over a period of time before access to a functionality of an electronic apparatus is provided. Further in at least on embodiment, access to functionality of the electronic apparatus can be provided in response to the heart rate data meeting the threshold for beats per minute over the period of time within an amount of time before the electronic apparatus receives the heart rate data and/or before a determination is made whether to provide access to the functionality of the electronic apparatus. For example, access to the functionality of the electronic apparatus can be provided in response to the heart rate of the user being within the threshold for the period of time for specified dates. The specification of dates can include a particular number of consecutive days, specific individual dates, or other numbers of days. The present disclosure advantageously promotes health by encouraging and/or incentivizing behavioral and/or environmental changes. In the context of the present disclosure, behavioral changes are changes made with respect to habits associated with exercise (e.g., increased exercise) and/or use of electronic apparatuses (e.g., decreased use). Environmental changes are changes made with respect to access to the functionality of electronic apparatuses (e.g., a decrease in access).

A user's heart rate (e.g., measured in beats per minute) can have a direct relationship with caloric expenditure. In at least one embodiment, the threshold for beats per minute is a minimum number of beats per minute. In at least one embodiment, the threshold for beats per minute is a range of beats per minute. For example, the threshold can correspond to a “target heart rate” range that provides an efficient rate of caloric expenditure. In some embodiments, such a range can be between 60% and 85% of a user's maximum heart rate, where the user's maximum heart rate is defined as (220 minus the age of the user in years). This information can be used to manage a user's caloric expenditure. A previous lack of behavioral and/or environmental incentives and/or changes may be one of the biggest road blocks to individuals utilizing their target heart rate to manage their caloric expenditure.

It is to be understood the present disclosure is not limited to particular machines or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

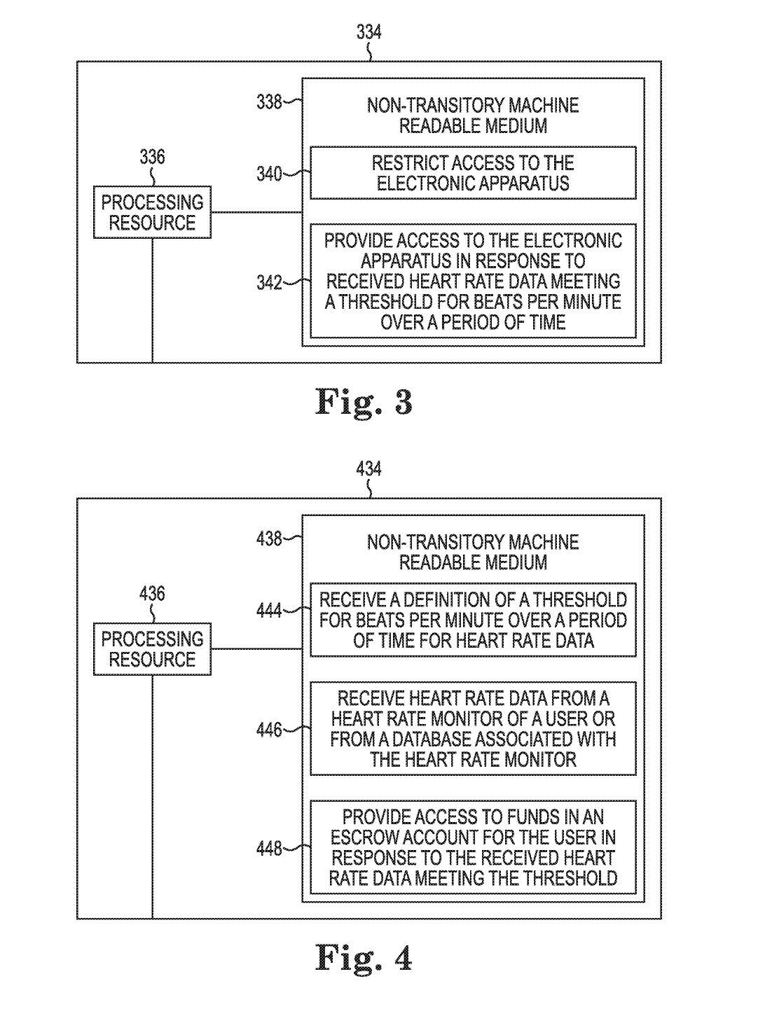

The figures herein follow a numbering convention in which the first digit or digits correspond to the drawing figure number and the remaining digits identify an element or component in the drawing. Similar elements or components between different figures may be identified by the use of similar digits. For example, 336 may reference element “36” in FIG. 3, and a similar element may be referenced as 436 in FIG. 4. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

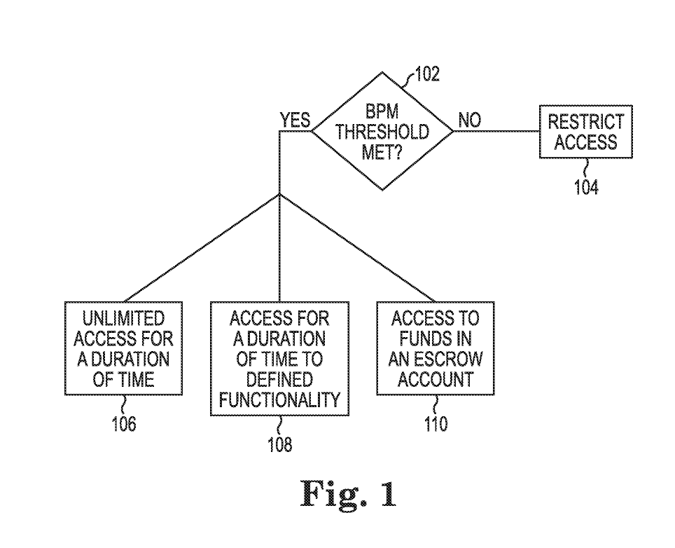

FIG. 1 illustrates a method flow diagram for heart rate data based access. At 102 the method can include making a determination whether a beats per minute (BPM) threshold is met for heart rate data. If the beats per minute threshold is not met, then at 104 the method can include restricting access. If the beats per minute threshold is met, then the method can include providing unlimited access for a duration of time at 106 or providing access for a duration of time to a defined functionality at 108. Elements 106 and 108 are alternative results of the beats per minute threshold being met at element 102. Providing unlimited access for the duration of time can include providing access to a plurality of electronic apparatuses, each of which can have a same or different duration of time for which access is provided. Providing unlimited access to a particular electronic apparatus means that the electronic apparatus is essentially “unlocked” such that any functionality of the electronic apparatus can be accessed by the user. In contrast, providing access to a defined functionality can include providing access to one or more particular functionalities of an electronic apparatus or electronic apparatuses such as applications, etc., as described herein.

In at least one embodiment, the method also includes providing access to funds in an escrow account at 110 if the beats per minute threshold is met at 102. Element 110 is an optional addition to element 106 or element 108 in response to the beats per minute threshold being met at 102. As will be described in more detail herein, providing access to funds in an escrow account can include automatically transferring money from one online pay service account to another. For example, an interested party may want to motivate a user to exercise and may be willing to provide monetary awards if the user can prove the exercise via heart rate data. Thus, the interested party can put money in an escrow account, such as an online pay service account, which can be accessed in response to the user's heart rate data meeting the threshold for beats per minute over a period of time. Examples of online pay service accounts include PayPal®, Google Wallet, Android Pay, Venmo, Square Cash, and Apple Pay, among others.

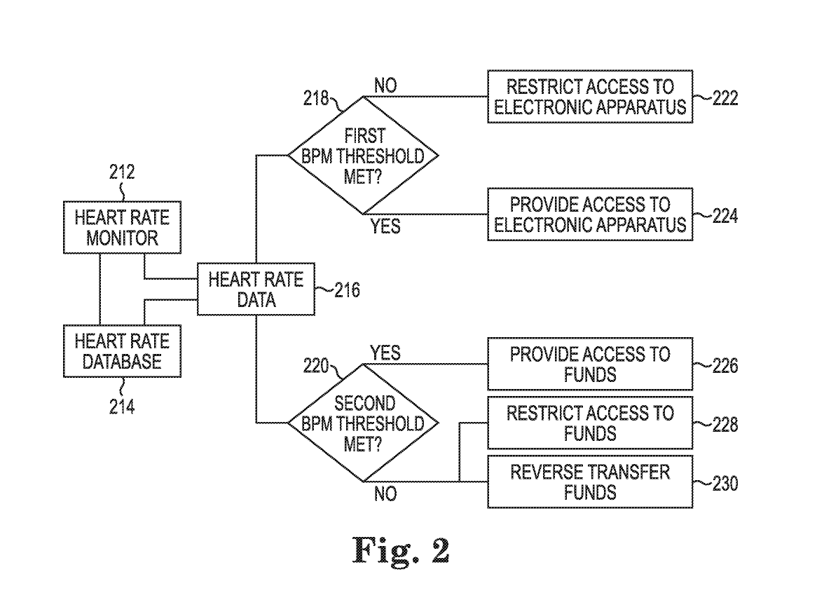

FIG. 2 illustrates a flow chart for heart rate data based access. Heart rate data 216 can be received directly from a heart rate monitor 212 of a user. Heart rate data 216 can be received from a heart rate database 214 (e.g., after the heart rate monitor 212 uploads the heart rate data 216 to the heart rate database 214). A heart rate monitor 212 can be an electronic device, such as a wearable device or an implantable device that can measure heart rate data such as beats per minute. In at least one embodiment, the heart rate monitor 212 can store the heart rate data 216 prior to and/or after uploading the heart rate data 216 to the heart rate database 214 or elsewhere. Thus, in some embodiments, the heart rate monitor 212 can include a non-transitory machine-readable medium. In at least one embodiment, the heart rate monitor can include a processing resource such as a processor, an application specific integrated circuit, or the like. The heart rate monitor 212 can transfer the heart rate data 216 in a wired or wireless fashion. For example, the heart rate monitor 212 can transfer the heart rate data via a USB cable, via Bluetooth, via Wi-Fi, or via other mechanical or electromagnetic transfer mechanisms.

Some embodiments can include a determination of whether a first beat per minute threshold has been met as indicated at 218. The first beat per minute threshold can be associated with access to a functionality of the electronic apparatus. A determination of whether a second beat per minute threshold has been met, as indicated at 220, can be associated with access to funds. In at least one embodiment, the first threshold and the second threshold can be the same threshold (e.g., the same number of beats per minute over a same time period). However, embodiments are not so limited as the first and the second thresholds can be different. Likewise, the first and the second thresholds can be associated with different time periods. For example, the first threshold can be a minimum of 110 beats per minute for 30 minutes and the second threshold can be a minimum of 160 beats per minute for 10 minutes.

If the first threshold is not met, then access to the functionality of the electronic apparatus can be restricted as shown at 222. However if the first threshold is met, then access to the functionality of the electronic apparatus can be provided as shown at 224. In at least one embodiment, access can be provided to the functionality of the electronic apparatus for a duration of time. After the duration of time, access to the functionality of the electronic apparatus can be restricted.

If the second threshold is met, then access to the funds can be provided as illustrated at 226. If the second threshold is not met, then access to the funds can be restricted as illustrated at 228. In at least one embodiment, if the second threshold is not met, then a reverse transfer of funds can occur as shown at 230. As described in more detail herein, a reverse transfer of funds can occur from an escrow account (e.g., an online pay service account of the user) to an escrow account (e.g., an online pay service account) of the interested party. The possibility of such a reverse transfer can provide further motivation for the user to achieve the threshold for beats per minute over the period of time. That is, the possibility of losing money if the user does not exercise can further motivate the user to exercise. Although FIG. 2 illustrates the reverse transfer occurring if the second threshold is not met, embodiments are not so limited. The reverse transfer could instead be tied to the first threshold or to a different threshold. For example, if the first threshold is a lesser threshold (e.g., at least 110 beats per minute for 30 minutes) as compared to the second threshold (e.g., at least 160 beats per minute for 10 minutes), then the reverse transfer could be tied to failure to meet the lesser threshold (the first threshold in this example). Thus, in this example, the user, by meeting the first threshold could gain access to the functionality of the electronic apparatus and avoid the reverse transfer of funds. Then, if the user further achieved and met the second threshold, the user could be provided with access to the funds from the interested party's escrow account. However, if the user did not even meet the first threshold, then the user would both not be provided with access to the functionality of the electronic apparatus and would suffer the reverse transfer of funds. As described in more detail herein, the present disclosure can include various control modes that can allow the user or the interested party to set parameters such as thresholds for beats per minute, periods of time over which the threshold is to be met, conditions for access to funds and/or reverse transfer of funds, etc.

FIG. 3 illustrates a diagram of a non-transitory machine readable medium 338 for heart rate data based access. The medium 338 can be part of a machine 334 that includes a processing resource 336. The processing resource 336 can be configured to execute instructions stored on the non-transitory machine readable medium 338. For example, the non-transitory machine readable medium 338 can be any type of volatile or non-volatile memory or storage, such as random access memory (RAM), flash memory, read-only memory (ROM), storage volumes, a hard disk, or a combination thereof. When executed, the instructions can cause the processing resource 336 to provide access based on heart rate data.

The medium 338 can store instructions 340 executable by the processing resource 336 to restrict access to the functionality of the electronic apparatus. The medium 338 can further store instructions 342 executable by the processing resource 336 to provide access to the functionality of the electronic apparatus in response to received heart rate data meeting a threshold for beats per minute over a period of time.

In some embodiments, the medium 338 can further store instructions executable by the processing resource 336 to provide access to the functionality of the electronic apparatus for a duration of time and to restrict access to the functionality of the electronic apparatus after the duration of time. The instructions to provide access to the functionality of the electronic apparatus can be executable in response to the heart rate data meeting the threshold for beats per minute over the period of time within an amount of time before the electronic apparatus receives the heart rate data. For example, the amount of time could be one day, meaning that access would only be provided if the heart rate data was no more than a day old when it was provided (e.g., so that the user could not try to access the functionality of the electronic apparatus using stale heart rate data, such as from an old workout). In at least one embodiment, the instructions to restrict access to the electronic apparatus comprise instructions to restrict access to functionality of the electronic apparatus. Examples of such functionality include, among others, a program, a game, a web browser, a web browser for a particular website, an application, a dialer, a dialer for a particular telephone number, a text message application, and a text message application for a recipient.

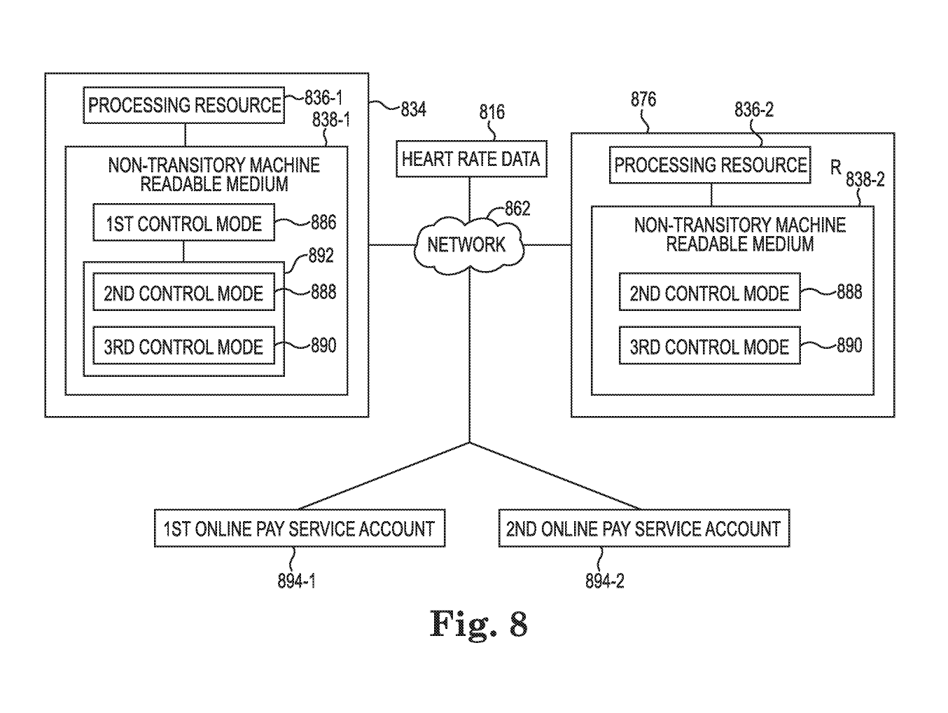

In some embodiments, the medium 338 can further store instructions executable by the processing resource 336 to provide a first control mode, a second control mode, and/or a third control mode for the electronic apparatus. The various control modes are described in more detail with respect to FIG. 8. In some embodiments, the medium 338 can further store instructions executable by the processing resource 336 to receive the heart rate data from a heart rate monitor (e.g., wired or wirelessly). In at least one embodiment, the medium 338 can further store instructions executable by the processing resource 336 to receive the heart rate data from a database associated with the heart rate monitor. The instructions stored on the medium 338 can be downloaded and/or installed on the electronic apparatus (e.g., where the electronic apparatus is a smartphone, the instructions can be downloaded and/or installed on the smartphone as an app).

The heart rate data can be received by either directly uploading it from a heart rate monitor or by utilizing an application programming interface (API) of a heart rate monitor. Once the heart rate data has been uploaded, it can be saved in association with the user (e.g., in a user account). The electronic apparatus can access the heart rate data of the user to check if the user has met the beats per minute threshold set before access to the functionality thereof is provided.

FIG. 4 illustrates a diagram of a non-transitory machine readable medium 438 for heart rate data based access. The medium 438 can be part of a machine 434 that includes a processing resource 436. The medium 438 can store instructions 444 executable by the processing resource 436 to receive a definition of a threshold for beats per minute over a period of time for heart rate data. The medium 438 can further store instructions 446 executable by the processing resource 436 to receive heart rate data from a heart rate monitor of a user or from a database associated with the heart rate monitor. The medium 438 can further store instructions 448 executable by the processing resource 436 to provide access to funds in an escrow account for the user in response to the received heart rate data meeting the threshold.

In some embodiments, the instructions to provide access to the funds can comprise instructions to transfer the funds from a first online pay service account to a second online pay service account, where the escrow account comprises the first online pay service account. For example, the escrow account/first online pay service account can be established by an interested party who is willing to contribute funds for the user if the user exercises enough to have a heart rate that meets the threshold. The second online pay service account can be an online pay service account of the user.

In some embodiments, the medium 438 can further store instructions executable by the processing resource 436 to transfer funds from the second online pay service account to the first online pay service account in response to the received heart rate data not meeting the threshold. For example, if the user does not exercise sufficiently such that his heart rate meets the threshold, then funds can be transferred from the user's account to the interested party's account. This additional feature adds a “stick” to the “carrot” of being provided with access to the device and/or to functionality of the device or the “carrot” of having funds transferred as a reward for exercising. In at least one embodiment, the medium 438 can further store instructions executable by the processing resource 436 to provide a first control mode, a second control mode, and/or a third control mode for the electronic apparatus as described in more detail with respect to FIG. 8.

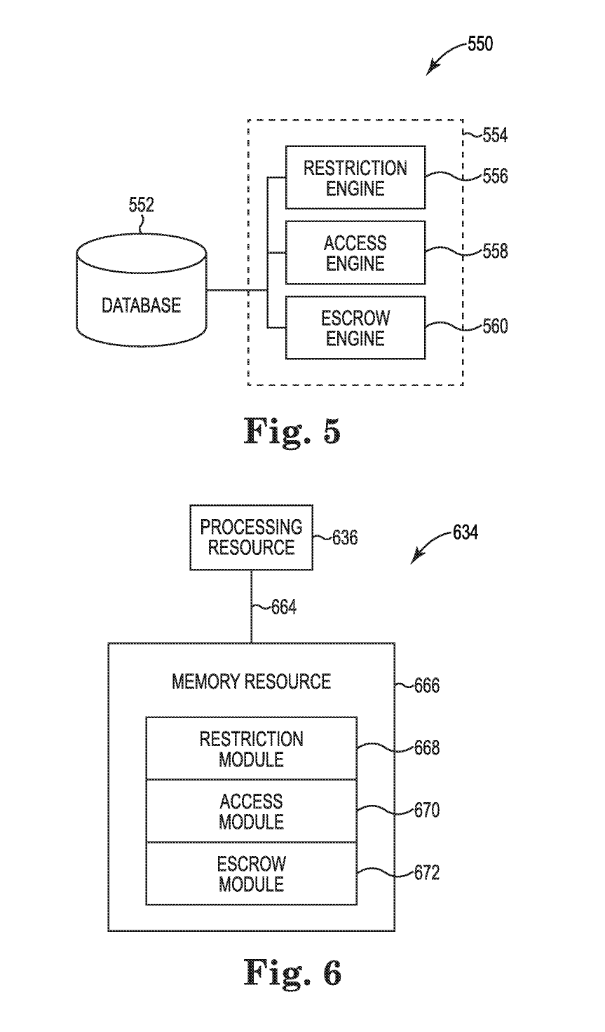

FIG. 5 illustrates a diagram of a system 550 for heart rate data based access. The system 550 can include a data store 552, a subsystem 554, and/or a number of engines (e.g., restriction engine 556, access engine 558, and/or escrow engine 560) and can be in communication with the data store 552 via a communication link. The system 550 can include additional or fewer engines than illustrated to perform the various functions described herein. The system can represent program instructions and/or hardware of a machine (e.g., machine 634 as referenced in FIG. 6, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions, such as software, firmware, etc., can be stored in a memory resource such as a machine-readable medium, machine-readable medium, etc., as well as hard-wired program such as logic. Hard-wired program instructions can be considered as both program instructions and hardware.

The restriction engine 556 can include a combination of hardware and program instructions that is configured to restrict access to a functionality of the electronic apparatus. The access engine 558 can include a combination of hardware and program instructions that is configured to provide access to the functionality of the electronic apparatus in response to received heart rate data meeting a first threshold for beats per minute over a first period of time. The escrow engine 560 can include a combination of hardware and program instructions that is configured to provide access to funds in an escrow account in response to the received heart rate data meeting a second threshold for beats per minute over a second period of time. In at least one embodiment, the first threshold for beats per minute and the second threshold for beats per minute are the same, however embodiments are not limited as the thresholds can be different. In at least one embodiment, the first period of time and the second period of time are the same, however embodiments are not so limited as the periods of time can be different.

Although not specifically illustrated, the system 550 can include a profile engine configured to maintain a respective profile type for each of a plurality of types of users (e.g., interested parties and users as described above). A first profile type can correspond to a first user type comprising a payee and provider of the heart rate data (e.g., the user). A second profile type can correspond to a second user type comprising a payor (e.g., the interested party). Although not specifically illustrated, the system 550 can include a control mode engine configured to provide a first control mode, a second control mode, and/or a third control mode for the system 550, as described in more detail with respect to FIG. 8.

FIG. 6 illustrates a diagram of a machine 634 for heart rate data based access. The machine 634 can utilize software, hardware, firmware, and/or logic to perform a number of functions. The machine 634 can be a combination of hardware and program instructions configured to perform a number of functions (e.g., actions). The machine 634 can be analogous to the machine 334 illustrated in FIG. 3 and/or the machine 434 illustrated in FIG. 4. The hardware, for example, can include a number of processing resources 636 and a number of memory resources 666, such as a machine-readable medium or other non-transitory memory resources 666. The memory resources 666 can be internal and/or external to the machine 634, for example, the machine 634 can include internal memory resources and have access to external memory resources. The program instructions, such as machine-readable instructions, can include instructions stored on the machine-readable medium to implement a particular function, for example, an action such as providing access based on heart rate data. The set of machine-readable instructions can be executable by one or more of the processing resources 636 (e.g., processors). The memory resources 666 can be coupled to the machine 634 in a wired and/or wireless manner. For example, the memory resources 666 can be an internal memory, a portable memory, a portable disk, and/or a memory associated with another resource, for example, enabling machine-readable instructions to be transferred and/or executed across a network such as the Internet. As used herein, a “module” can include program instructions and/or hardware, but at least includes program instructions.

Memory resources 666 can be non-transitory and can include volatile and/or non-volatile memory. Volatile memory can include memory that depends upon power to store information, such as various types of dynamic random access memory among others. Non-volatile memory can include memory that does not depend upon power to store information. Examples of non-volatile memory can include solid state media such as flash memory, electrically erasable programmable read-only memory, phase change random access memory, magnetic memory, optical memory, and/or a solid state drive, etc., as well as other types of non-transitory machine-readable media.

The processing resources 636 can be coupled to the memory resources 666 via a communication path 664. The communication path 664 can be local or remote to the machine 634. Examples of a local communication path 664 can include an electronic bus internal to a machine, where the memory resources 666 are in communication with the processing resources 636 via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path 664 can be such that the memory resources 666 are remote from the processing resources 636, such as in a network connection between the memory resources 666 and the processing resources 636. That is, the communication path 664 can be a network connection. Examples of such a network connection can include a local area network, wide area network, personal area network, and the Internet, among others.

As shown in FIG. 6, the machine-readable instructions stored in the memory resources 666 can be segmented into a number of modules 668, 670, 672 that when executed by the processing resources 636 can perform a number of functions. As used herein a module includes a set of instructions included to perform a particular task or action. The number of modules 668, 670, 672 can be sub-modules of other modules. For example, the restriction module 668 can be a sub-module of the access module 670 and/or the restriction module 668 and the access module 670 can be contained within a single module. Furthermore, the number of modules 668, 670, 672 can comprise individual modules separate and distinct from one another. Examples are not limited to the specific modules 668, 670, 672 illustrated in FIG. 6.

Each of the number of modules 668, 670, 672 can include program instructions and/or a combination of hardware and program instructions that, when executed by a processing resource 636, can function as a corresponding engine as described with respect to FIG. 5. For example, the restriction module 668 can include program instructions and/or a combination of hardware and program instructions that, when executed by a processing resource 636, can function as the restriction engine 556, the access module 670 can include program instructions and/or a combination of hardware and program instructions that, when executed by a processing resource 636, can function as the access engine 558, and/or the escrow module 672 can include program instructions and/or a combination of hardware and program instructions that, when executed by a processing resource 636, can function as the escrow engine 560.

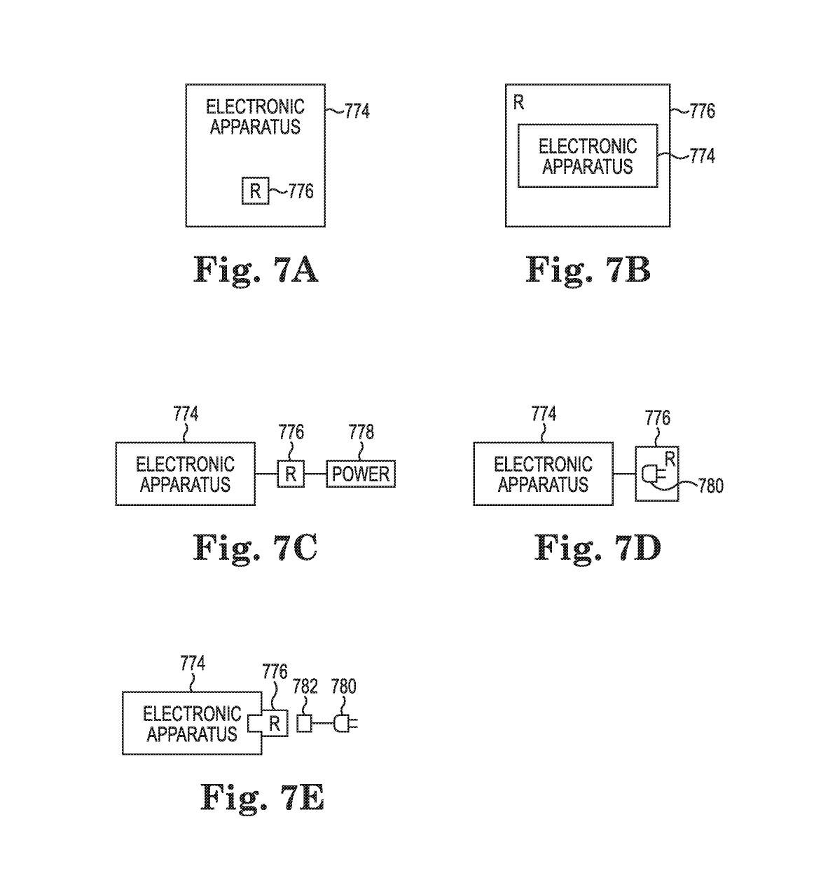

FIGS. 7A-7E illustrate diagrams of examples of systems for heart rate data based access to an electronic apparatus. As described herein, examples of the electronic apparatus 774 include televisions, computers (e.g., desktops and/or laptops), tablets, smartphones, gaming systems (e.g., PlayStation®, Xbox®, etc.), among others. Various embodiments of the restrictive component 776 (depicted by the letter “R”) are included in FIGS. 7A-7E. The restrictive component 776 is intended to illustrate how access to the functionality of the electronic apparatus 774 is restricted. For example, the restrictive component can operate as element 104 in FIG. 1, element 222 in FIG. 2, element 340 in FIG. 3, element 556 in FIG. 5, and/or element 668 in FIG. 6.

The embodiment illustrated in FIG. 7A includes restrictive component 776 embedded in the electronic apparatus 774. Thus, for example, the restrictive component 776 can be executable instructions in the form of software or hardware (e.g., logic) that is integrated into the electronic apparatus 774.

Although not specifically illustrated in FIG. 7A, one mechanism by which the restrictive component 776 can restrict use of the electronic apparatus 774 is by interrupting power internal to the electronic apparatus 774 so that the electronic apparatus cannot function until the restrictive component 776 stops interrupting power. Another mechanism by which the restrictive component 776 can restrict access to the electronic apparatus 774 is by overriding the functionality of the electronic apparatus 774 by software or hardware control (e.g., while still allowing power to be provided internal to the electronic apparatus 774). In association with such overriding, the restrictive component 776 can cause a message to be displayed on a screen of or associated with the electronic apparatus that informs a user of the electronic apparatus 774 that access has been restricted until appropriate heart rate data is received. The restrictive component 776 can receive heart rata data in a wired or wireless fashion as described above.

Such embodiments may be useful where the electronic apparatus 774 allows for relatively straight forward incorporation of the restrictive component 776 therein, such as a computer that can be modified with software to provide the restrictive component 776, or a smartphone or tablet that can be modified with an application to provide the restrictive component 776.

The embodiment illustrated in FIG. 7B includes restrictive component 776 that physically surrounds the electronic apparatus 774. An example of such physically surrounding restrictive component 776 is a lockbox. The lockbox can be a physical apparatus with an electronic control system (e.g., to lock or unlock the lockbox) embodied by the restrictive component 776 that can restrict and/or provide access to the electronic apparatus 774 (and thereby to the functionality of the electronic apparatus 774) according to the parameters described herein with respect to heart rate data. The restrictive component 776 can receive heart rata data in a wired or wireless fashion as described above. The restrictive component 776 can include executable instructions in the form of software or hardware (e.g., logic) that is integrated into the lockbox in order to operate a lock associated with the lockbox. In order to restrict access to the electronic apparatus 774, the restrictive component 776 can lock the lockbox. In order to provide access to the electronic apparatus 774, the restrictive component 776 can unlock the lockbox, which allows a user to access and operate the electronic apparatus 774.

Such embodiments may be useful where the electronic apparatus 774 is relatively small, such as a smartphone, laptop, tablet, or gaming system because the relatively small electronic apparatus 774 would not require a large lockbox. Such embodiments may also be useful where the electronic apparatus 774 is not easily modified to provide the restrictive component internally (e.g., such as a gaming system whose manufacturer may not allow for modification of an operating system in order to provide the restrictive component 776 internally as in FIG. 7A).

The embodiment illustrated in FIG. 7C includes restrictive component 776 that is provided as a physical component between the electronic apparatus 774 and a power source 778 for the electronic apparatus 774. For example, the restrictive component 776 can be built into a power outlet that is a power source 778 for the electronic apparatus 774. The restrictive component 776 can restrict use of the electronic apparatus 774 is by interrupting power external to the electronic apparatus 774 so that the electronic apparatus cannot function until the restrictive component 776 stops interrupting power. The restrictive component 776 can include executable instructions in the form of software or hardware (e.g., logic) that provides the restrictive component 776 (e.g., controls whether power is provided from the power source 778 to the electronic apparatus 774). The restrictive component 776 can receive heart rata data in a wired or wireless fashion as described above.

Such embodiments may be useful for instances where the electronic apparatus 774 either does not include an internal power source (such as a battery) or where the electronic apparatus 774 has a relatively short-lived internal power source, such that a user may desire to plug in the electronic apparatus 774 for customary use. Such embodiments may be useful where the electronic apparatus is relatively large or immobile (e.g., such as a television) so that the user may not simply or easily move the electronic apparatus 774 to a different power source 778.

The embodiment illustrated in FIG. 7D includes restrictive component 776 that is provided as a physical component surrounding a power cord 780 for the electronic apparatus 774. An example of such physically surrounding restrictive component 776 is a lockbox analogous to that described with respect to FIG. 7B, except that in this embodiment, the lockbox surrounds the power cord 780 of the electronic apparatus 774 rather than surrounding the entire electronic apparatus 774. The restrictive component 776 can include executable instructions in the form of software or hardware (e.g., logic) that provides the restrictive component 776 (e.g., locks or unlocks to allow the power cord 780 to be plugged into a power source). The restrictive component 776 can receive heart rata data in a wired or wireless fashion as described above.

Such embodiments may be useful for instances where the electronic apparatus 774 either does not include an internal power source (such as a battery) or where the electronic apparatus 774 has a relatively short-lived internal power source, such that a user may desire to plug in the electronic apparatus 774 for customary use. Such embodiments may be useful where the electronic apparatus 774 is relatively large such that surrounding the entire electronic apparatus 774 with a lockbox is impractical. Such embodiments may also be useful where the electronic apparatus 774 is not easily modified to provide the restrictive component internally (e.g., such as a gaming system whose manufacturer may not allow for modification of an operating system in order to provide the restrictive component 776 internally as in FIG. 7A).

The embodiment illustrated in FIG. 7E includes restrictive component 776 that is provided as a physical component locked into a power receptacle of the electronic apparatus 774 where an input 782 of a power cord 780 would normally be inserted. An example of such physically surrounding restrictive component 776 is a lockbox analogous to that described with respect to FIG. 7D, except that in this embodiment, the lockbox prevents the input 782 of the power cord 780 of the electronic apparatus 774 from being inserted rather than surrounding the power cord 780. The restrictive component 776 can include executable instructions in the form of software or hardware (e.g., logic) that provides the restrictive component 776 (e.g., locks or unlocks to allow the input 782 of the power cord 780 to be plugged into the electronic apparatus 774). The restrictive component 776 can receive heart rata data in a wired or wireless fashion as described above.

Such embodiments may be useful for instances where the electronic apparatus 774 either does not include an internal power source (such as a battery) or where the electronic apparatus 774 has a relatively short-lived internal power source, such that a user may desire to plug in the electronic apparatus 774 for customary use. Such embodiments may be useful where the electronic apparatus 774 is relatively large such that surrounding the entire electronic apparatus 774 with a lockbox is impractical. Such embodiments may also be useful where the electronic apparatus 774 is not easily modified to provide the restrictive component internally (e.g., such as a gaming system whose manufacturer may not allow for modification of an operating system in order to provide the restrictive component 776 internally as in FIG. 7A).

FIG. 8 illustrates a system for heart rate data based access. The system can include a machine 834, a restrictive component 876, and a network 862 that can connect the machine 834 to the restrictive component 876. Heart rate data 816 can also be connected to the network 862 (e.g., from a heart rate monitor and/or from a database storing the heart rate data 816). The network 862 can be the Internet, a LAN, other forms of networks, or combinations thereof. The network 862 can also be connected to a first online pay service account 894-1 and a second online pay service account 894-2.

The machine 834 can be analogous to the machine 334 illustrated in FIG. 3, the machine 434 illustrated in FIG. 4, and/or the machine 634 illustrated in FIG. 6. The machine 834 can include a processing resource 836-1 and a non-transitory machine readable medium 838-1. The medium 838-1 can store instructions executable to provide a first control mode 886, a second control mode 888, and a third control mode 890 for the restrictive component 876, which is associated with an electronic apparatus. For example, the machine 834 can be a general purpose computer that can be used to configure the instructions comprising the first control mode 886, a second control mode 888, and a third control mode 890. The first control mode 886 can be used to generate and/or configure the second control mode 888 and the third control mode 890. In some embodiments, the second control mode 888 and the third control mode 890 can be transmitted to the restrictive component 876 via the network 862 as a package 892. Accordingly, the second control mode 888 and the third control mode 890 in the medium 838-1 of the machine 834 and in the non-transitory machine readable medium 838-2 of the restrictive component 876 can be copies of each other.

The restrictive component 876 can be analogous to the restrictive component 776 illustrated and described with respect to FIGS. 7A-7E. Although not specifically illustrated in FIG. 8, the restrictive component 876 can be provided to restrict access to an electronic apparatus. The restrictive component 776 can be connected externally to the electronic apparatus or be internal to the electronic apparatus. The restrictive component can comprise hardware and/or software. As illustrated in FIG. 8, the restrictive component can include a processing resource 836-2 connected to a non-transitory machine readable medium 838-2. The medium 838-2 can store executable instructions comprising the second control mode 888 and the third control mode 890. The restrictive component 876 can function in accordance with the second control mode 888 and the third control mode 890 as opposed to the machine 834, which can configure the instructions comprising the first control mode 886, a second control mode 888, and a third control mode 890, rather than function according thereto. In at least one embodiment, the machine 834 can operate an interface, such as a web-based interface, to configure the instructions comprising the first control mode 886, a second control mode 888, and a third control mode 890, transmit the second control mode 888 and a third control mode 890 to the restrictive component 876, and/or edit the first control mode 886, a second control mode 888, and a third control mode 890. That is, the first control mode 886 can be provided as a web-based interface to the restrictive component 876. The machine 834 can edit the second control mode 888 and/or the third control mode 890 in the medium 838-1 and/or the medium 838-2.

The first control mode 886 can be referred to as a “main profile,” the second control mode 888 can be referred to as a “safe mode” or “restricted access mode,” and the third control mode 890 can be referred to as a “sub-profile.” The first control mode 886 can be analogized to having administrator-level privileges with respect to the restrictive component 876. For example, in the first control mode 886, the restrictive component 876 can receive a definition of the functionality of the electronic apparatus to which access is to be restricted. This effectively allows the restrictive component 876 to be configured. The second control mode 888 can be analogized to user-level restrictions as defined by the first control mode 886. For example, in the second control mode 888, the restrictive component 876 can restrict access to the functionality of the electronic apparatus for a user. The third control mode 890 can be analogized to user-level access as defined by the first control mode 886. For example, in the third control mode 890, the restrictive component 876 can allow access to the functionality of the electronic apparatus for the user. In operation, the restrictive component 876 can first be configured by an administrator (e.g., the interested party, the user of the heart rate monitor, or another individual) in the first control mode 886, which then causes the restrictive component 876 to operate in a second control mode 888, where access to the functionality of the electronic apparatus for the user of the heart rate monitor is restricted. In order to go from the second control mode 888 to the third control mode 890, the heart rate data 816 for the user would have to meet the threshold for beats per minute over the period of time (e.g., as defined by the first control mode 886).

The first control mode 886 can enable the restrictive component 876 to receive a definition of a functionality of the electronic apparatus to be restricted in the second control mode 888. Examples of such functionality include programs, apps, phone numbers, and/or websites that can be restricted when the second control mode 888 is engaged. For example, the first control mode 886 can define that “gaming apps, youtube.com, or text messaging” are not allowed when the second control mode 888 is engaged for the user's smartphone.

The first control mode 886 can enable the restrictive component 876 to receive a definition of a duration of time for which access is to be granted to the functionality in the third control mode 890. For example, it may be desirable to limit access to the functionality of the electronic apparatus to an hour. The first control mode 886 can enable the restrictive component 876 to receive a definition of when the second control mode 888 is to be engaged. For example, it may be desirable to engage the second control mode 888 during certain times of day or certain days of the week. Or it may not be desirable to engage the second control mode 888 while the user is on vacation. The first control mode 886 can enable the restrictive component 876 to receive a definition of the period of time over which the threshold for beats per minute is to be met. For example, the period of time could be defined as a desired workout time (e.g., 30 minutes, an hour, etc.). The first control mode 886 can enable the restrictive component 876 to receive a definition of the amount of time before the electronic apparatus receives the heart rate data for which the heart rate data will be operable to provide access to the electronic apparatus (e.g., how “old” the heart rate data can be).

The first control mode 886 can enable the restrictive component 876 to receive a definition of a threshold for beats per minute over a period of time for the heart rate data 816. For example, the threshold can be a minimum beats per minute or a range of beats per minute. Different thresholds can be used for access to different functionalities of the electronic apparatus. For example, a first threshold can be defined for access to a first functionality and a second threshold can be defined for access to a second functionality. Likewise, different thresholds can be defined for access to functionality of the electronic apparatus and for transfer of funds as described herein. The first control mode 886 can enable the restrictive component 876 to receive a definition of a first and a second threshold for beats per minute over a period of time for heart rate data and to receive a definition of an amount of funds to be transferred from a first online pay service account 894-1 (e.g., an account of the interested party) to a second online pay service account 894-2 (e.g., an account of the user). For example, the interested party can define how much money to transfer each time the user meets the threshold. The first control mode 886 can enable the restrictive component 876 to receive a definition of a subsequent date at which to transfer funds from the first online pay service account 894-1 to the second online pay service account 894-2 in response to subsequently received heart rate data 816 meeting the relevant threshold. For example, the interested party can define a “next time” that funds will be available for transfer to the user so that the user cannot necessarily qualify for the funds each day even if sufficient exercise is completed. Each interested party and user can agree to usage terms and save their online pay service account information and password in association with the restrictive component 876. Once the account information and password have been saved, the funds can be transferred between accounts in response to the threshold being met.

The second control mode 888 can enable the restrictive component 876 to restrict access to the defined functionality of the electronic apparatus. The second control mode 888 can enable the restrictive component 876 to receive the heart rate data 816. The second control mode 888 can enable the restrictive component 876 to engage the third control mode 890 in response to the received heart rate data 816 meeting the threshold. The user must provide heart rate data 816 that meets the threshold set by the first control mode 886 in order to transition from the second control mode 888 to the third control mode 890. If the threshold is not met, then the user only has access to the functionality of the electronic apparatus (e.g., apps, programs, phone numbers, and/or websites) as has been approved for use while the second control mode 888 is engaged. If the threshold is met, then customized access can be provided for a duration of time, preset by the first control mode 886. If a user attempts to access a functionality to which access is restricted by the first control mode 886 while the restrictive component 876 is in the second control mode 888, the restrictive component 876 can compare the user's heart rate data 816 to the threshold set by the first control mode 886. If the threshold is not met then access is restricted. If the threshold is met then the user is granted access past the second control mode 888 for the duration of time defined by the first control mode 886. For example, the first control mode 886 can define that access to the third control mode 890 is limited to a duration of time of 45 minutes per day and only if the user meets the defined threshold of 143-167 beats per minute for 45 minutes that day. If the user meets the threshold, then access can be provided to the third control mode 890 for the defined 45 minutes. If the user does not meet the threshold then access is completely or partially restricted, based on the definitions set by the first control mode 886.

The third control mode 890 can enable the restrictive component 876 to grant access to the defined functionality of the electronic apparatus for the defined duration of time. The third control mode 890 can enable the restrictive component 876 to engage the second control mode after the defined duration of time.

The third control mode 890 can enable the restrictive component 876 to transfer the defined funds from the first online pay service account 894-1 to the second online pay service account 894-2 in response to the heart rate data 816 meeting a defined threshold for such a transfer. As described herein, the first online pay service account 894-1 can function as an escrow account to store funds from an interested party to be transferred to the user as a reward for exercising properly. There can be different thresholds for different amounts of funds to be transferred. The third control mode 890 can enable the restrictive component 876 to transfer funds from the second online pay service account 894-2 to the first online pay service account 894-1 in response to the received heart rate data not meeting the threshold. As described herein, such a reverse transfer can be a punishment for the user not exercising properly. There can be a different threshold for such a reverse transfer than for the forward transfer. For example, a lower beats per minute threshold can be used for the reverse transfer (meaning that the user does not have to exercise very hard to avoid the reverse transfer) and a higher threshold for the forward transfer (meaning that the user has to exercise harder to receive the forward transfer). The thresholds for the forward and/or reverse transfers can be the same or different than the thresholds for access to the functionality of the electronic apparatus.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for heart rate data based access, comprising:
restricting access to a functionality of an electronic apparatus via a restrictive component;
receiving heart rate data for a user via the restrictive component;
providing access to the functionality of the electronic apparatus for a duration of time via the restrictive component in response to the received heart rate data meeting a threshold for beats per minute over a period of time; and
restricting access to the functionality of the electronic apparatus after the duration of time.

2. The method of claim 1, wherein providing access to the functionality of the electronic apparatus further comprises providing access to the functionality of the electronic apparatus in response to the heart rate data meeting the threshold within an amount of time before the heart rate data is received.

3. The method of claim 2, further including:
receiving a definition of the threshold for beats per minute;
receiving a definition of the period of time;
receiving a definition of the duration of time; and
receiving a definition of the amount of time.

4. The method of claim 3, wherein receiving the heart rate data comprises receiving the heart rate data from a heart rate monitor or receiving the heart rate data from a database associated with the heart rate monitor.

5. The method of claim 1, wherein the threshold for beats per minute is a minimum number of beats per minute.

6. The method of claim 1, wherein the threshold for beats per minute is a range of beats per minute.

7. A non-transitory machine-readable medium storing instructions executable by a processing resource to:
provide a first control mode, a second control mode, and a third control mode of a restrictive component associated with an electronic apparatus;
wherein the first control mode enables the restrictive component to:
receive a definition of a functionality of the electronic apparatus to be restricted in a second control mode;
receive a definition of a duration of time for which access is to be granted to the functionality in a third control mode; and
receive a definition of a threshold for beats per minute over a period of time for heart rate data;
wherein the second control mode enables the restrictive component to:
restrict access to the functionality;
receive heart rate data for a user; and
engage the third control mode in response to the received heart rate data meeting the threshold; and
wherein the third control mode enables the restrictive component to:
grant access to the functionality for the duration of time; and
engage the second control mode after the duration of time.

8. The medium of claim 7, wherein the first control mode enables the restrictive component to receive a definition of an amount of funds to be transferred from a first online pay service account of an interested party to a second online pay service account for a user;
wherein the third control mode enables the restrictive component to transfer the funds in response to received heart rate data meeting the threshold.

9. The medium of claim 8, wherein the third control mode enables the restrictive component to transfer funds from the second online pay service account to the first online pay service account in response to the received heart rate data not meeting the threshold.

10. The medium of claim 8, wherein the first control mode enables the restrictive component to receive a definition of a subsequent date at which to transfer funds from the first online pay service account to the second online pay service account in response to subsequently received heart rate data meeting the threshold.

11. The medium of claim 7, wherein the first control mode enables the restrictive component to:
receive a definition of a first threshold for beats per minute over a period of time for heart rate data;
receive a definition of a second threshold for beats per minute over a period of time for heart rate data; and
receive a definition of an amount of funds to be transferred from a first online pay service account of an interested party to a second online pay service account for a user;
wherein the second control mode enables the restrictive component to engage the third control mode in response to the received heart rate data meeting the first threshold; and
wherein the third control mode enables the restrictive component to transfer the funds in response to received heart rate data meeting the second threshold.

12. The medium of claim 7, wherein the functionality of the electronic apparatus comprises one or more of the group of functionalities including:
a application that can run on the electronic apparatus;
a game that can be played using the electronic apparatus;
a web browser of the electronic apparatus;
access to a particular website via a web browser of the electronic apparatus;
a dialer of the electronic apparatus;
access to a particular telephone number via a dialer of the electronic apparatus;
a text message application of the electronic apparatus; and
access to a particular recipient via a text message application of the electronic apparatus.

13. The medium of claim 7, wherein the functionality of the electronic apparatus comprises overall operation of the electronic apparatus.

14. The medium of claim 7, wherein the instructions are executable to provide the first control mode as a web-based interface with the restrictive component.

15. A system for heart rate data based access, comprising:
a restrictive component configured to:
restrict access to a functionality of an electronic apparatus;
receive heart rate data from a heart rate monitor of a user or a database associated with the heart rate monitor; and
provide access to the functionality of the electronic apparatus in response to the received heart rate data meeting a first threshold for beats per minute over a first period of time; and
an escrow engine configured to provide access to funds in an escrow account for the user in response to the received heart rate data meeting a second threshold for beats per minute over a second period of time.

16. The system of claim 15, wherein the restrictive component is coupled between the electronic apparatus and a power source for the electronic apparatus; and
wherein the restrictive component is configured to restrict access to the functionality of the electronic apparatus by preventing the electronic apparatus from being powered by the power source.

17. The system of claim 15, wherein the restrictive component encloses the electronic apparatus; and
wherein the restrictive component is configured to restrict access to the functionality of the electronic apparatus by preventing a user from physically accessing the electronic apparatus.

18. The system of claim 15, wherein the restrictive component comprises first instructions executable by the electronic apparatus;
wherein the functionality of the electronic apparatus comprises second instructions executable by the electronic apparatus; and
wherein the restrictive component is configured to restrict access to the functionality of the electronic apparatus by preventing the electronic apparatus from executing the second instructions.

19. The system of claim 15, wherein the first threshold for beats per minute and the second threshold for beats per minute are the same.

20. The system of claim 15, wherein the first period of time and the second period of time are the same.
